(19) United States
(12) Patent Application Publication
(10) Pub. No.: US 2025/0011130 A1
(43) Pub. Date: Jan. 9, 2025

(54) ELEVATOR SYSTEMS

(71) Applicant: OTIS ELEVATOR COMPANY, Farmington, CT (US)

(72) Inventors: Jan Ruhnke, Berlin (DE); Andrew The, Berlin (DE)

(21) Appl. No.: 18/746,336

(22) Filed: Jun. 18, 2024

(30) Foreign Application Priority Data
Jul. 6, 2023 (EP) 23183837.6

(51) Int. Cl. B66B 5/00; B66B 1/06; B66B 1/46; B66B 1/52; B66B 11/02

(52) U.S. Cl. CPC B66B 5/0087; B66B 1/06; B66B 11/0246; B66B 1/468; B66B 1/52; B66B 2201/102

(57) ABSTRACT

An elevator system is provided which comprises an elevator shaft, an elevator car located within the elevator shaft and comprising an operational compartment and a top structure located above the operational compartment, and a controller. The controller is arranged to control the elevator car to move in the elevator shaft such that the operational compartment serves a plurality of landings in response to elevator service requests. The controller receives a top structure access command, and in response to receiving the top structure access command, controls the elevator car to move in the elevator shaft such that the top structure is aligned with a landing of the plurality of landings.

### CROSS-REFERENCE TO RELATED APPLICATION

This application is a U.S. non-provisional application claiming the benefit of European Application No. 23183837.6, filed on Jul. 6, 2023, which is incorporated herein by reference in its entirety.

### TECHNICAL FIELD

The present disclosure relates to elevator systems and particularly to elevator systems that can facilitate access to the top of an elevator car.

### BACKGROUND

Elevator systems typically feature one or more elevator cars that are movable vertically within an elevator shaft. It is occasionally necessary for a mechanic to access the top of an elevator car, e.g. during installation, testing or maintenance operations. Conventionally, to access the top of an elevator car, a mechanic located on a landing causes the car to move downwards (e.g. by inputting a car call to a lower floor, and then exiting the car) and then manually triggers an emergency stop of the car precisely when the top of the car is aligned with the landing. This is typically done by forcing open the landing doors at exactly the right moment to trigger an emergency stop (because the landing doors should not be open when the car is moving). The mechanic can then access the top of the car through the open landing doors.

However, it can be difficult (e.g. for less experienced mechanics) to time the opening of the landing doors sufficiently accurately to stop the car with the top aligned with the landing, especially because in most systems the mechanic cannot see the elevator when the landing doors are closed. Having to re-position the car if the timing is wrong can be time-consuming.

Moreover, elevator systems have recently been proposed which can respond dynamically to emergency stop signals, e.g. to avoid unnecessary entrapments of passengers. For instance, EP 3960673 discloses an elevator system which, in some circumstances, allows an elevator car to move to a next landing in response to an emergency stop signal, instead of immediately applying the brake to stop the car as is conventional. However, this can complicate efforts to access the top of the car because, in such systems, the opening of the landing doors by the mechanic may not always cause the car to stop immediately.

An improved approach may be desired.

### SUMMARY

According to a first aspect of the present disclosure there is provided an elevator system comprising:
an elevator shaft;
   an elevator car located within the elevator shaft and comprising an operational compartment and a top structure located above the operational compartment; and
   a controller arranged:
      to control the elevator car to move in the elevator shaft such that the operational compartment serves a plurality of landings in response to elevator service requests;
      to receive a top structure access command; and
      in response to receiving a top structure access command, to control the elevator car move in the elevator shaft such that the top structure is aligned with a landing of the plurality of landings.

Thus, it will be recognized by those skilled in the art that the present disclosure provides an elevator system which can facilitate access to the top of the elevator car (sometimes referred to as top-of-car or TOC access). Because the controller actively controls the elevator car to align the top structure with a landing in response to a top structure access command, access to the top structure can be provided without a mechanic needing to enter the hoistway or the car and without relying on emergency stop procedures. The emergency stop procedures of the elevator system can thus, for instance, be optimized independently, e.g. to mitigate unnecessary passenger entrapments. Moreover, a mechanic may not need to rely on accurate manual timing to reliably access the top structure, simplifying maintenance processes and avoiding potential delays.

Part or all of the top structure access command may be received from another component of the elevator system. In other words, the elevator system may comprise one or more components operable to send part or all of a top structure access command to the controller. In some examples, the elevator system comprises a dedicated interface operable to issue part or all of a top structure access command (e.g. a user interface operable by a mechanic when they need to access the top structure of the car). For instance, the elevator system may comprise a dedicated top structure access command button that, when pressed, sends part or all of a top structure access command to the controller.

However, in many examples a dedicated top structure access command interface is not needed. In some examples, the elevator system comprises a multi-purpose interface arranged to send part or all of a top structure access command to a controller and to perform one or more other elevator functions. The multi-purpose interface may comprise a service panel, e.g. also operable to output diagnostic information and/or to issue other commands to the elevator system.

In some examples, the multi-purpose interface comprises a landing call input device (e.g. a hall call or destination call input device located in a landing), i.e. also
operable to issue elevator call signals (e.g. hall call signals or destination call signals). The elevator system may comprise a plurality of landing call input devices operable to issue elevator call signals and to issue part or all of a top structure access command. The plurality of landing call input devices may be located on different landings.

Re-purposing standard elevator system components to also issue part or all of a top structure access command may allow the overall component count of the elevator system to be reduced, whilst also facilitating retrofitting by reducing or eliminating the need for additional hardware to be installed. Using a landing call button may be particularly advantageous because they are typically already located adjacent or near to landing doors, i.e. from which a mechanic may wish to access the top structure.

One or more components of the elevator system may be arranged to send part or all of a top structure access command to the controller in response to a user interaction. The component(s) may comprise any suitable user interface, e.g. comprising one or more buttons, dials, knobs, touch-sensitive surfaces, keypads, microphones, cameras and/or sensors. For instance, a landing call input device may comprise one or more call buttons and the pressing of said one or more buttons may cause part or all of a top structure access command to be sent to the controller.

The user interaction may comprise a specific type of interaction and/or combination of interactions, e.g. a particular length of button press and/or a predetermined pattern of button presses. This type and/or combination may be different to one or more other possible user interactions with the component. This may allow standard and/or existing elevator system components to be repurposed to additionally provide top structure access functionality. For instance, a short press (e.g. <5 s) of a landing call input device button may cause the landing call input device to send a standard elevator call, whereas a long press (e.g. >5 s) may cause the landing call input device to send part or all of a top structure access command to the controller.

Because the top structure access command results in the elevator car moving to a non-standard position, it may be desirable to mitigate the possibility that a passenger accidentally causes a top structure access command to be issued. This may be achieved by physically restricting access to devices operable to issue a top structure access command (e.g. locking a service panel or locating a dedicated top structure access command interface in a plant room with restricted access). However, this may be inconvenient for mechanics and require additional hardware (e.g. complicating retrofit implementations).

Therefore, in a set of examples, the top structure access command comprises two or more parts, e.g. two or more constituent signals which form the top structure access command when received together and/or in a particular order. The top structure access command comprising two or more parts may reduce the possibility of it accidentally being issued.

In some examples, receiving the top structure access command comprises receiving a top structure access mode signal followed by a top structure access request signal. A top structure access mode signal may be validly combined with several subsequent top structure access request signals. For instance, a top structure access mode signal may put the controller into a top structure access mode in which any subsequent top structure access request signal constitutes a valid top structure access command until the top structure access mode is deactivated. This may, for instance, be helpful to a mechanic who requires top structure access at several distinct times in close succession.

However, in some examples, a top structure access mode signal can validly form a top structure access command with only a first subsequent top structure access request signal. In other words, each top structure mode signal and each top structure request signal may form only one top structure access command. More generally, each part of a top structure access command may only form one top structure access command. Having “one time use” parts of a top structure access command may further mitigate accidental activation.

In some sets of examples where the top structure access command comprises two or more parts, parts of the top structure access command may be received from different components of the elevator system. In some examples, a service panel may be operable to send a top structure access mode signal to the controller, and a landing call input device may be operable to send a top structure access request signal to the controller. For instance, a mechanic may interact with a service panel to cause it to issue the top structure access mode signal, and then interact with a landing call input device on the landing that they want to access the top structure from to cause it to issue a top structure access request signal.

In some examples, the elevator system is arranged to use only one landing for accessing the top structure. In such examples the controller may be arranged to control the elevator car to move such that the top structure is aligned with a particular landing of the plurality of landings in response to all top structure access commands (e.g. regardless of when and where they are issued).

However, in some situations it may be useful for the elevator system to be operable to provide top structure access from different landings. For instance, a mechanic may wish to access the top structure from the landing at which they are currently located. In a set of examples, the top structure access command indicates a desired top structure access landing. The landing with which the controller is arranged to align the top structure in response to a top structure access command may be based on the top structure access command (e.g. the landing may be a desired landing indicated by the top structure access command).

The top structure access command may comprise data indicating the desired landing (e.g. the command may include a “landing” data field). Additionally or alternatively, a source of the top structure access command may indicate the desired landing. For instance, the landing on which the component (e.g. landing call device) that sends part or all of the top structure access command is located may be the desired landing. In other words, in response to a top structure access command, the controller may be arranged to align the top structure with a landing on which a component that sends part or all of the top structure access command is located.

Different elevator cars and/or elevator systems feature different top structures. For instance, the top structure may comprise a higher or highest portion of a frame of the elevator car. In a set of examples, the top structure comprises a partial or complete platform, e.g. suitable for supporting a mechanic. The top structure may comprise a safety rail. In some examples, the top structure comprises a roof of an elevator car. The top structure may form and/or support a ceiling of the operational compartment.

The elevator system may be arranged for transporting passengers and/or cargo.

The operational compartment may comprise a passenger compartment. The operational compartment may comprise a cargo compartment. In some examples, the operational compartment comprises a call car interface, i.e. for a passenger to input their desired destination. However, this is not essential and examples of the present disclosure include destination-call elevator systems in which a desired destination is input outside of the car (e.g. prior to car assignment).

Control over movement of the elevator car (i.e. to serve landings and in response to the top structure access command) may be achieved in any suitable way. For instance, the elevator system may be suspended from a tension member (e.g. a rope or belt) and movement of the car may be controlled by controlling driving and/or braking force applied to the tension member (e.g. with a traction sheave). The elevator system may alternatively comprise a ropeless elevator system in which a linear motor and/or a hydraulic lift are controlled to move the car.

According to a second aspect of the present disclosure there is provided a method of operating an elevator system comprising an elevator shaft and an elevator car located within the elevator shaft and comprising an operational compartment and a top structure located above the operational compartment, the method comprising:
controlling the elevator car to move in the elevator shaft such that the operational compartment serves a plurality of landings in response to elevator service requests;
receiving a top structure access command; and
in response to receiving a top structure access command, controlling the elevator car move in the elevator shaft such that the top structure is aligned with a landing of the plurality of landings.

The present disclosure extends to a computer program product (e.g. embedded or controller software) comprising instructions which, when executed on a controller of an elevator system, causes the controller to perform the method disclosed herein.

The present disclosure also extends to a computer-readable non-transitory memory storing said computer program product.

Features of any aspect or example described herein may, wherever appropriate, be applied to any other aspect or example described herein. Where reference is made to different examples, it should be understood that these are not necessarily distinct but may overlap. It will be appreciated that all of the preferred features of the elevator system according to the first aspect described above may also apply to the other aspects of the disclosure.

### BRIEF DESCRIPTION OF THE DRAWINGS

One or more non-limiting examples will now be described, by way of example only, and with reference to the accompanying figures in which:

FIG. 1 is a schematic view of an elevator system for use in examples of the present disclosure;

FIG. 2 is a schematic view of an elevator system according to an example of the present disclosure; and

FIG. 3 is a flow diagram illustrating operation of the elevator system shown in FIG. 2.

### DETAILED DESCRIPTION

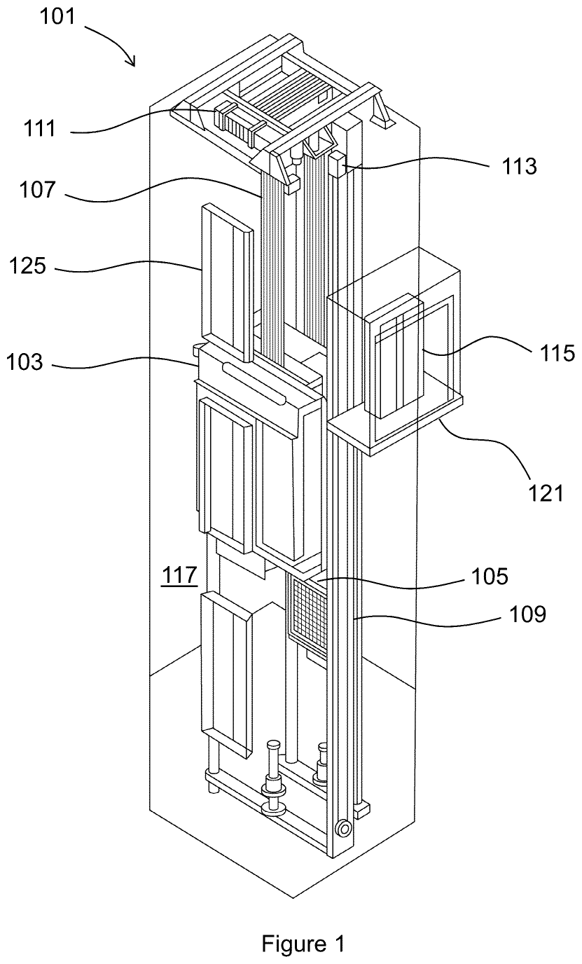

FIG. 1 shows an elevator system 101 including an elevator car 103, a counterweight 105, a tension member 107, a guide rail 109, an elevator machine 111, an encoder 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the elevator machine 111, which is part of an overhead structure of the elevator system 101. The elevator machine 111 is configured to control movement between the elevator car 103 and the counterweight 105, and thus control the position of the elevator car 103 within the elevator shaft 117. The encoder 113 may be mounted on a fixed part at the top of the elevator shaft 117, such as on a support or guide rail, and may be configured to provide position signals related to a position of the elevator car 103 within the elevator shaft 117. In other examples, the encoder 113 may be directly mounted to a moving component of the elevator machine 111, or may be located in other positions and/or configurations as known in the art. The encoder 113 can be any device or mechanism for monitoring a position of an elevator car 103 and/or counterweight 105, as known in the art.

The controller 115 is located, as shown, in a controller room 121 of the elevator shaft 117 and is configured to control the operation of the elevator system 101, and particularly the elevator car 103. For example, the controller 115 may provide drive signals to the elevator machine 111 to control the acceleration, deceleration, levelling, stopping, etc. of the elevator car 103. The controller 115 may also be configured to receive position signals from the encoder 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one examples, the controller may be located remotely or in the cloud.

The elevator machine 111 may include a motor or similar driving mechanism. The elevator machine 111 may be configured to include an electrically driven motor. The power supply for the motor may be any power source, including a power grid, which, in combination with other components, is supplied to the motor. The elevator machine 111 may include a traction sheave that imparts force to tension member 107 to move the elevator car 103 within elevator shaft 117.

Although shown and described with a roping system including a tension member 107, elevator systems that employ other methods and mechanisms of moving an elevator car within an elevator shaft may employ examples of the present disclosure. For example, examples may be employed in ropeless elevator systems using a linear motor to impart motion to an elevator car. Examples may also be employed in ropeless elevator systems using a hydraulic lift to impart motion to an elevator car. FIG. 1 shows merely a non-limiting example presented for illustrative and explanatory purposes. Features of the elevator system 101 may be applied to the elevator system described below.

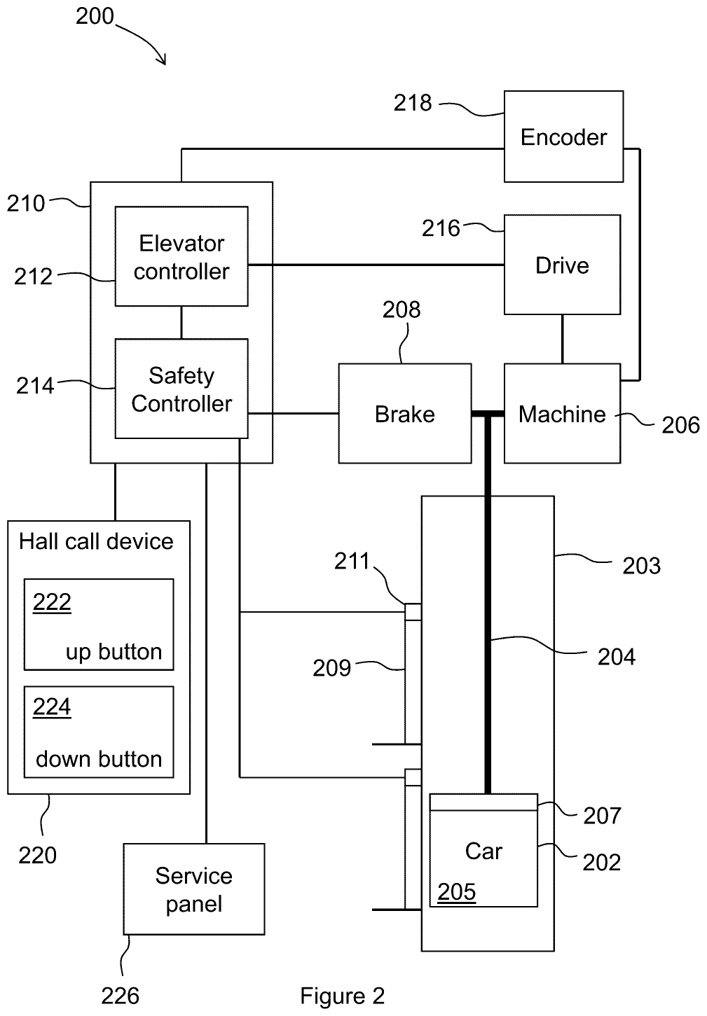

FIG. 2 is a schematic illustration of an elevator system 200 in accordance with an example of the present disclosure. As shown, the elevator system 200 comprises an elevator car 202 which is movable in an elevator shaft 203 between a plurality of landings. Two landings are illustrated in FIG. 2 but the elevator system 200 may comprise many more, e.g. more than five landings. Each landing has a landing door 209 opening onto the elevator shaft and a landing door sensor 211 (and/or a landing door switch) which detects the open/closed state of the associated landing door 209.

The elevator car 202 comprises a passenger compartment 205 (although the present disclosure is also applicable to cargo elevators which do not carry passengers) and a top structure 207. The top structure 207 forms the roof of the passenger compartment 205.

The elevator car 202 is coupled by a tension member 204 which is driven by an elevator machine 206. The elevator machine 206 is thus operable to move the elevator car 202, via the tension member 204, in the elevator shaft.

A brake 208, in the form of a machine brake, is arranged to act directly on the machine 206 such that when the brake 208 is applied movement of the machine 206 is stopped, and consequently the elevator car 202 is stopped from moving within the elevator shaft. Whilst the brake 208 illustrated is a machine brake 208, any other form of brake that can suitably stop movement of the elevator car 202 within the elevator shaft may also be used.

The elevator system 200 comprises a controller 210 which comprises an elevator controller 212 and a safety controller 214. The elevator controller 212 is operatively connected to a drive 216 which in turn is connected to the elevator machine 206 to control operation of the elevator machine 206, and thus control movement of the elevator car 202 within the elevator shaft. In this example, an encoder 218 is arranged to measure the position and speed of the elevator car 202, based on movement of the elevator machine 206. The encoder 218 is operatively connected to the elevator controller 212 to enable to elevator controller 212 to suitably control the elevator machine 206 to drive the elevator car 202 in the desired manner. The encoder 218 may be used to determine the position, speed, acceleration, deceleration of the elevator car 202.

As depicted, the safety controller 214 is operatively connected directly to the brake 208. Accordingly, the safety controller 214 can directly control the brake 208, without reliance upon any other controller. As described above, this may help to ensure that the safety controller 214 can quickly and reliably operate the brake 208 as it is not dependent on any other component.

The landing door sensors 211 are operatively coupled to the safety controller 214. The landing door sensors 211 may form part of a safety chain (e.g. a series-connected circuit of sensors and/or switches that controls directly or indirectly the application of the brake 208). Although not illustrated in FIG. 2, the elevator system 200 may comprise additional safety devices which are operatively coupled to the safety controller 214 (e.g. a speed sensor).

The elevator system 200 further comprises a hall call device 220. Although only one hall call device 220 is illustrated in FIG. 2, the system features a plurality of hall call devices 220, with one located on each landing (e.g. adjacent the landing door 209). The hall call device 220 comprises an up button 222 and a down button 224.

Finally, the elevator system 200 comprises a service panel 226. The service panel 226 may be operable by a mechanic to monitor and/or configure various parameters of the elevator system 200.

In normal use, a passenger who wishes to travel from one landing to another presses the up or down button 222, 224 of the hall call device 220 of the landing they are on to request elevator service in a desired direction. The elevator controller 212 processes the request and controls the drive 216 to move the elevator car 202 such that the passenger compartment 205 arrives at the appropriate landing to serve the call.

Although not shown in FIG. 2, the elevator car 202 features a car call device to allow a user to specify their destination landing when they board the elevator car 202. The elevator controller 212 processes this destination request and controls the drive 216 to move the elevator car 202 such that the passenger compartment 205 arrives at the destination landing to serve the request.

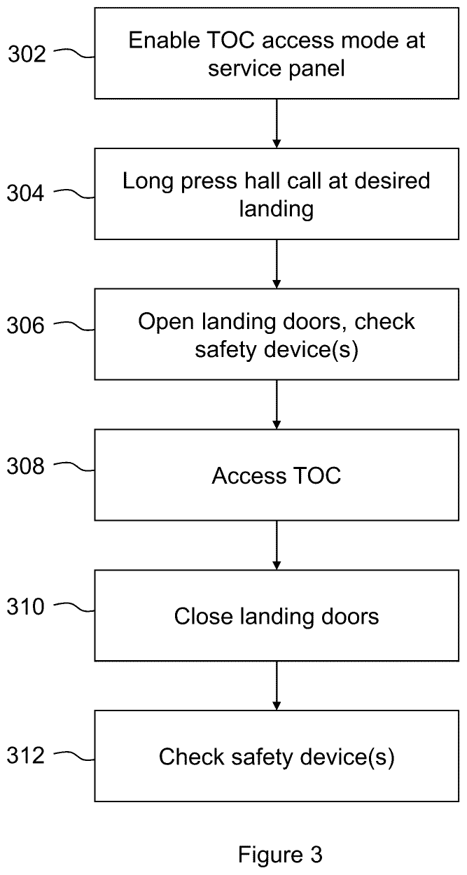

It is occasionally necessary for a mechanic to access the top of the elevator car 202, e.g. to carry out inspection and/or maintenance of components located in the elevator shaft 203 or on top of the elevator car 202. A method for doing so according to an example of the present disclosure will now be described with additional reference to FIG. 3.

In a first step 302, the mechanic uses the service panel 226 to enable a top structure access mode. This is a first stage in issuing a top structure access command to the controller 210. The top structure access mode may be the same as an emergency rescue operation (ERO) mode, or it may be another (e.g. newly defined) mode, such as a dedicated top structure access mode.

Then, the mechanic moves to the landing from which they would like to access the top structure 207 of the elevator car 202. In step 304, the mechanic performs a long press (e.g. 5s) of the hall call up button 222. This completes the top structure access command. In other examples the mechanic may complete the top structure access command with other inputs, e.g. other patterns of button presses.

In response to the top structure access command, the controller 210 controls the drive 216 to move the elevator car 202 such that the top structure 207 is aligned with the landing at which the mechanic is waiting.

In step 306, the mechanic opens the landing door 209, and checks that the landing door sensors 211 (and any other safety device(s)) are functioning properly. This may involve inputting a car call in the elevator car 202 but preventing the landing door 209 from closing. If the corresponding landing door sensor 211 is working correctly its output should cause the safety controller to prevent movement of the elevator car 202.

In step 308, the mechanic accesses the top of the elevator car 202, e.g. carrying out any inspection and/or maintenance work.

Once the necessary inspection/maintenance has been carried out, the mechanic exits the hoistway and closes the landing door 209 in step 310. Finally, in step 312, the mechanic re-checks the landing door sensors 211 and any other safety device(s) before the elevator system 200 returns to normal service. This final step 312 is not mandatory and may not be included in many examples.

Thus, the mechanic can accurately position the elevator car 202 for top structure access from outside the hoistway without relying on manual timings or emergency stop procedures.

When the top structure access mode is enabled, only one instance of top structure access positioning is allowed before the top structure access mode must be enabled again at the service panel 226. In other words, each enabling of the top structure access mode forms the first stage of a single top structure access command. This prevents normal passengers from accidentally triggering another top structure access command.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of the disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. An elevator system comprising:
an elevator shaft;
an elevator car located within the elevator shaft and comprising an operational compartment and a top structure located above the operational compartment; and
a controller arranged:
to control the elevator car to move in the elevator shaft such that the operational compartment serves a plurality of landings in response to elevator service requests;
to receive a top structure access command; and
in response to receiving the top structure access command, to control the elevator car to move in the elevator shaft such that the top structure is aligned with a landing of the plurality of landings.

2. The elevator system of claim 1, comprising a multi-purpose interface arranged to issue part or all of the top structure access command and to perform one or more other elevator functions.

3. The elevator system of claim 2, wherein the multi-purpose interface comprises a service panel.

4. The elevator system of claim 2, wherein the multi-purpose interface comprises at least one landing call input device.

5. The elevator system of claim 4, wherein the at least one landing call input device comprises a plurality of landing call input devices located on different landings of the plurality of landings and operable to issue elevator call signals and to issue part or all of the top structure access command.

6. The elevator system of claim 1, wherein one or more components of the elevator system is arranged to send part or all of the top structure access command to the controller in response to a user interaction.

7. The elevator system of claim 6, wherein the user interaction comprises a specific type of interaction and/or combination of interactions.

8. The elevator system of claim 1, wherein the top structure access command comprises two or more parts.

9. The elevator system of claim 8, wherein each part of the top structure access command may only form one top structure access command.

10. The elevator system of claim 1, wherein receiving the top structure access command comprises receiving a top structure access mode signal followed by a top structure access request signal.

11. The elevator system of claim 10, comprising a service panel operable to send a top structure access mode signal to the controller, and a landing call input device operable to send a top structure access request signal to the controller.

12. The elevator system of claim 1, wherein the top structure access command indicates a desired top-of-car access landing.

13. The elevator system of claim 1, wherein the top structure comprises a roof of the elevator car.

14. A method of operating an elevator system comprising an elevator shaft and an elevator car located within the elevator shaft and comprising an operational compartment and a top structure located above the operational compartment, the method comprising:
controlling the elevator car to move in the elevator shaft such that the operational compartment serves a plurality of landings in response to elevator service requests;
receiving a top structure access command; and
in response to receiving the top structure access command, controlling the elevator car to move in the elevator shaft such that the top structure is aligned with a landing of the plurality of landings.

15. A computer program product comprising instructions which, when executed on a controller of the elevator system, causes the controller to perform the method of claim 14.
